(19) United States
(12) Patent Application Publication
(10) Pub. No.: US 2026/0249227 A1
(43) Pub. Date: Aug. 27, 2026

(54) FILTER ELEMENT AND FILTER SYSTEM

(71) Applicant: MANN+HUMMEL GmbH, Ludwigsburg (DE)

(72) Inventors: Klaus-Dieter RUHLAND, Meckenheim (DE); Michael KAUFMANN, Meckenheim (DE); Pascal NEEF, Trossingen (DE)

(21) Appl. No.: 19/649,526

(22) Filed: Apr. 16, 2026

Related U.S. Application Data
(63) Continuation of application No. PCT/EP2024/079101, filed on Oct. 16, 2024.

(30) Foreign Application Priority Data
Oct. 23, 2023 (DE) 10 2023 129 009.6

(51) Int. Cl. B01D 46/52

(52) U.S. Cl. CPC B01D 46/522; B01D 2275/201; B01D 2275/206

(57) ABSTRACT

A filter element for fluid has a folded filter medium body arranged around a longitudinal axis with first folds in a first angular segment and second folds in a second angular segment. The first folds have first outer fold edges lying on an outer cylindrical wall surface and radially opposed first inner fold edges lying on an inner cylindrical wall surface. The second folds have second outer fold edges lying on the outer cylindrical wall surface and radially opposed second inner fold edges lying on an inner conical wall surface. Alternatively, the second inner fold edges lie on the inner cylindrical wall surface and the second outer fold edges lie on an outer conical wall surface outside of the inner cylindrical wall surface. A housing of a matching filter system has a coupling element with a cutout engaging the second angular segment of the filter element.

### CROSS-REFERENCE TO RELATED APPLICATIONS

This application is a continuation application of international application No. PCT/EP2024/079101 having an international filing date of Oct. 16, 2024, and designating the United States, the international application claiming a priority date of Oct. 23, 2023, based on prior filed German patent application No. 10 2023 129 009.6, the entire contents of the aforesaid applications being incorporated herein by reference to the fullest extent permissible.

### BACKGROUND

The invention concerns a filter element for a filter system for a fluid, for example air, for example of an internal combustion engine, as well as a filter system for a fluid, for example air, for example of an internal combustion engine, including at least one filter element.

WO 00/25893 discloses a filter system with a housing in which a round filter cartridge is installed. A component of the round filter cartridge is a filter medium which is formed of a flat material, e.g. nonwoven or paper, which is foldable. The filter medium is folded such that the outer edges of the filter folds lie on a cylindrical wall. The inner folds of the filter medium form a conical inner space in the round filter cartridge. The outlet of the round filter cartridge is provided on the side at which the interior of the round filter cartridge has the larger diameter. The exterior, i.e., the installation volume of the round filter cartridge, includes a cylindrical shape, on the other hand.

EP 3 156 115 A1 describes a filter element for filtering a fluid, including a pleated filter body which is arranged around a longitudinal axis and includes a closed circumference, wherein the filter body includes folds which extends along the longitudinal axis from a first end face to a second end face of the filter body. Inner fold edges of the folds form an inner wall and outer fold edges of the folds form an outer wall of the filter body. In this context, at least one of the folds is divided into two or more folds along its longitudinal extension.

US 2017/0050137 A1 describes a cylindrical filter element with a filter medium body which at an inner or outer diameter has a flat region across the entire length.

EP 2 535 550 A2 discloses a cylindrical filter element with a filter medium body which, at its outer wall surface, includes a groove across the entire length for a reliable rotational position mounting.

### SUMMARY

It is an object of the invention to provide a filter element for a filter system for a fluid, for example air, for example of an internal combustion engine, which may be conveniently coupled to a housing of the filter system.

A further object of the invention is to provide a filter system with such a filter element which may be conveniently coupled to a housing of the filter system.

The aforementioned object is solved according to an aspect of the invention by a filter element for a filter system for a fluid, for example air, for example of an internal combustion engine, including at least one filter medium body with a filter medium folded substantially in a star shape, which is arranged around a longitudinal axis and includes a closed circumference and includes a first end face and a second end face oppositely positioned thereto, wherein the filter medium body, in at least one first angular segment around the longitudinal axis, includes first folds with outer fold edges, which lie on an outer cylindrical wall surface, and with radially oppositely positioned inner fold edges, which lie on an inner cylindrical wall surface arranged inwardly in radial direction inside the outer cylindrical wall surface, and includes, at least in one region along the longitudinal axis at the same axial height in at least one second angular segment, second folds with outer fold edges, which lie on the outer cylindrical wall surface, and with radially oppositely positioned inner fold edges, which lie on a conical wall surface arranged inside of the outer cylindrical wall surface in a radial direction, or includes, at least in one axial region along the longitudinal axis at the same axial height in at least one second angular segment, second folds with inner fold edges, which lie on an inner cylindrical wall surface, and with radially oppositely positioned outer fold edges, which lie on a conical wall surface arranged outside of the inner cylindrical wall surface in a radial direction.

According to another aspect of the invention, the further object is solved by a filter system for a fluid, for example air, for example of an internal combustion engine, including at least one filter element as previously described, including a housing with a first housing part and a second housing part, a fluid inlet arranged at the housing for supplying the fluid to be filtered, and a fluid outlet arranged at the housing for discharging the filtered fluid, wherein a coupling element of the housing, when mounting the filter element as intended, engages in a longitudinal direction at least one second angular segment of the filter medium body of the filter element including a conical wall surface.

Embodiments and advantages of the invention result from the further description, and the accompanying drawings.

According to an embodiment of the invention, a filter element for a filter system for a fluid, for example air, for example of an internal combustion engine, is proposed, including at least one filter medium body with a filter medium folded substantially in a star shape, which is arranged around a longitudinal axis and includes a closed circumference and includes a first end face and a second end face oppositely positioned thereto. The filter medium body includes, in at least one first angular segment around the longitudinal axis, first folds with outer fold edges, which lie on an outer cylindrical wall surface, and with radially oppositely positioned inner fold edges, which lie on an inner cylindrical wall surface arranged inside of the outer cylindrical wall surface in a radial direction. The filter medium body includes, at least in one region along the longitudinal axis at the same axial height in at least one second angular segment, second folds with outer fold edges, which lie on the outer cylindrical wall surface, and with radially oppositely positioned inner fold edges, which lie on a conical wall surface arranged inside of the outer cylindrical wall surface in the radial direction. As an alternative, the filter medium body includes, at least in one region along the longitudinal axis at the same axial height in at least one second angular segment, second folds with inner fold edges, which lie on an inner cylindrical wall surface, and with radially oppositely positioned outer fold edges, which lie on a conical wall surface arranged outside of the inner cylindrical wall surface in the radial direction. The proposed filter element includes a filter medium body with a filter medium folded in a star shape, which includes a closed circumference and thus is embodied as a hollow cylinder, for example. As an alternative, the filter medium body may be configured in a different shape closed around the longitudinal axis. In this context, the filter medium body includes, at least in a first portion of its circumference, in a first angular segment around the longitudinal axis, a cylindrical shape and, in at least one other portion of its circumference, in a second angular segment around the longitudinal axis, a so-called half-conical shape. The half-conical shape of the filter medium body is created in that between the first folds of the filter medium, the second folds are formed by additional folding so that the fold height at an end face of the filter medium body corresponds to half the height of the fold height at the other end face of the filter medium body. In the region of the half-conical shape, fold edges of the second folds lie on a cylindrical wall surface and radially oppositely positioned fold edges on a conical wall surface. The filter medium body may be formed in this manner along the entire longitudinal extension of the filter medium body. As an alternative, only a subregion along the longitudinal extension of the filter medium body may be formed in this manner.

In this manner, an additional coupling possibility with a secondary element and/or with the housing of the filter system is provided. In this way, an oriented installation of the filter element in the filter housing is possible. In addition, an anti-rotation safeguard of the filter element may be implemented.

The second folds of the filter medium body may be created in that each first fold is folded inwardly again at an end face whereby a conical folding is produced. In this manner, the filter medium body, at least in one angular segment, may include outwardly a cylindrical wall surface and inwardly a conical wall surface or outwardly a conical wall surface and inwardly a cylindrical wall surface.

On the circumference of the filter medium body, angular segments with half-conical shape and cylindrical shape may be arranged alternatingly. The conical wall surface may be arranged in this context on the outer circumference or on the inner circumference.

The filter element may be used in a filter system with a single-stage or a two-stage embodiment with cyclone separation. Such filter systems are used, for example, in construction machines and agricultural machines.

The alternating angular segments with half-conical shape and cylindrical shape may be arranged on a secondary filter element, if present, or on a main filter element.

The at least regionally half-conical shape of the filter medium body is favorable in regard to a larger inflow cross section and enables in this way a reduced pressure loss upon flow through the filter element.

According to an embodiment of the filter element, in the at least one second angular segment including the conical wall surface, two or more second folds may be present along the longitudinal axis in at least one of the first folds of the filter medium body. For example, first folds may be present at the first end face and second folds may be present at the second end face in the at least one second angular segment in this context. By dividing the first folds into two or more second folds, the fold height at this end face may be significantly reduced and the conical angle of the filter medium body may be enlarged in this way. The second folds are slanted toward the longitudinal axis. For example, a first fold may be divided into two second folds. Optionally, a first fold may be divided into more than two second folds. Correspondingly, the number of folds in the second angular segment is increased compared to the first angular segment.

According to an embodiment of the filter element, a fold height of the second folds in the at least one second angular segment may change continuously along the longitudinal axis. The conical wall surface may be designed in that between the folds of the filter medium additional folds are formed so that the fold height at an end face of the filter medium body corresponds to half the height of the fold height at the other end face of the filter medium body.

According to an embodiment of the filter element, the second folds in the at least one second angular segment may include half the fold height of the fold height of the first folds in the at least one first angular segment. Due to the difference in fold height, an angle-precise and anti-rotation mounting of the filter element in the housing of the filter system may be ensured.

According to an embodiment of the filter element, the filter medium body may include a support tube arranged in the interior, wherein the inner cylindrical wall surface of the filter medium body formed in the first angular segment engages a corresponding cutout of the support tube formed in the longitudinal direction. In this manner, an angle-precise and anti-rotation mounting of the filter element in the housing of the filter system may be ensured.

According to an embodiment of the filter element, the first and the second end faces of the filter medium body may include an end disc, respectively. In this context, the first and the second end faces of the filter medium body may be for example overmolded with the material of the end disc. The end disc ensures a safe mounting and sealing of the filter element in the housing of the filter system.

According to an embodiment of the filter element, the support tube may be embedded in the respective end disc, for example overmolded. In this manner, a secure and permanent connection between support tube and end disc may be ensured.

According to an embodiment of the filter element, the end discs may include circumferential seals protruding in longitudinal direction. In this context, the seals may be for example integrated into the end discs. A reliable sealing action between raw side and clean side in the housing of the filter system may thus be conveniently achieved.

According to an embodiment of the filter element, first angular segments and second angular segments may be arranged alternatingly on a circumference of the filter medium body. In this way, an anti-rotation mounting of the filter element in the housing of the filter system may be ensured. At the same time, in this manner a coding for matching filter elements and filter systems is enabled.

According to an embodiment of the filter element, at least one portion of the outer cylindrical wall surface of the filter medium body may be covered by an inflow guard. In this way, a sensitive filter medium may be protected from the pressure of the inflowing fluid. In addition, coarse dirt particles may thus be pre-separated. Loading of the filter medium of the filter element by these dirt particles may be prevented.

According to a further aspect of the invention, a filter system for a fluid, for example air, for example of an internal combustion engine, with at least one filter element is proposed, including a housing with a first housing part and a second housing part, a fluid inlet arranged at the housing for supplying the fluid to be filtered, and a fluid outlet arranged at the housing for discharging the filtered fluid. In this context, a coupling element of the housing engages in a longitudinal direction at least a second angular segment of a filter medium body of the filter element including a conical wall surface, when mounting the filter element in the housing of the filter system as intended.

In the proposed filter system, there exists thus an additional coupling possibility between the filter element and the housing of the filter system. In this way, an oriented installation of the filter element in the filter housing is possible. In addition, an anti-rotation safeguard of the filter element in the filter housing may be implemented in this way.

The filter element includes a filter medium body with a filter medium folded in a star shape, which includes a closed circumference and is thus embodied as a hollow cylinder, for example. As an alternative, the filter medium body may be configured in a different shape closed around the longitudinal axis. In this context, the filter medium body includes a cylindrical shape at least at a first portion of its circumference, in a first angular segment around the longitudinal axis, and a half-conical shape at least at one other portion of its circumference, in a second angular segment around the longitudinal axis. The half-conical shape of the filter medium body is created in that, between the first folds of the filter medium, second folds are formed by additional folding so that the fold height at one end face of the filter medium body corresponds to half the height of the fold height at the other end face of the filter medium body. In the region of the half-conical shape, fold edges of the second folds lie on a cylindrical wall surface and radially oppositely positioned fold edges on a conical wall surface.

Angular segments with half-conical shape and cylindrical shape may be arranged alternatingly on the circumference of the filter medium body. The conical wall surface may be arranged on the outer circumference or on the inner circumference in this context.

The filter element may be used in a filter system in a single-stage or a two-stage embodiment with cyclone separation. Such filter systems are used, for example, in construction machines and agricultural machines.

According to an embodiment of the filter system, the coupling element may include a cutout in the region of at least one first angular segment of the filter medium body including a cylindrical wall surface. In this way, the filter element may be mounted securely in a fixed angular position around the longitudinal axis in the filter housing and may be supported reliably with anti-rotation action in the filter housing.

According to an embodiment of the filter system, the coupling element may be configured as a housing-fixed central tube which receives the filter element when mounted as intended. In this context, an inner cylindrical wall surface formed in at least one first angular segment may engage a corresponding cutout of the central tube formed in the longitudinal direction. In this way, the filter element may be mounted securely in a fixed angular position around the longitudinal axis in the filter housing and may be supported reliably with anti-rotation action in the filter housing.

### BRIEF DESCRIPTION OF THE DRAWINGS

Further advantages result from the following drawing description. In the drawings, embodiments of the invention are illustrated. The drawings, the description, and the appended claims contain numerous features in combination. A person of skill in the art will consider the features expediently also individually and combine them to expedient further combinations.

FIG. 1 shows a section illustration of a filter system for a fluid, for example air, for example of an internal combustion engine, with a filter element according to an embodiment of the invention.

FIG. 2 shows an isometric illustration of the filter element according to an embodiment of the invention.

FIG. 3 shows a section illustration of the filter element according to FIG. 2.

FIG. 4 shows a schematic illustration of the transition from first folds to second folds of the folded filter medium.

FIG. 5 shows a plan view of a second end face of the filter element according to FIG. 2.

FIG. 6 shows an inner view of the first housing part of the filter system according to FIG. 1.

FIG. 7 shows a section illustration through the filter system in the section plane A-A according to FIG. 1.

### DETAILED DESCRIPTION

In the drawing figures, same or same-type components are identified with like reference characters. The drawing figures show only examples and are not to be understood as limiting.

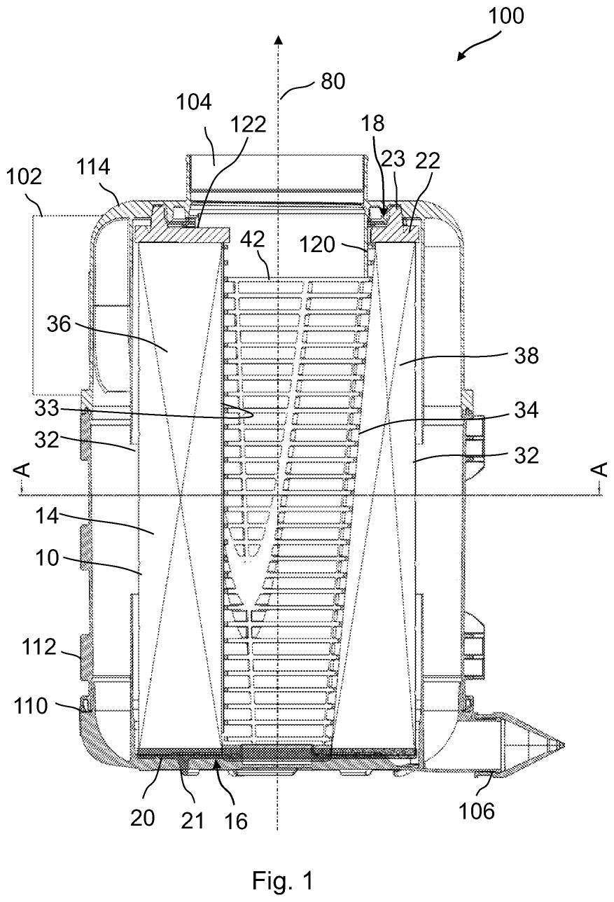

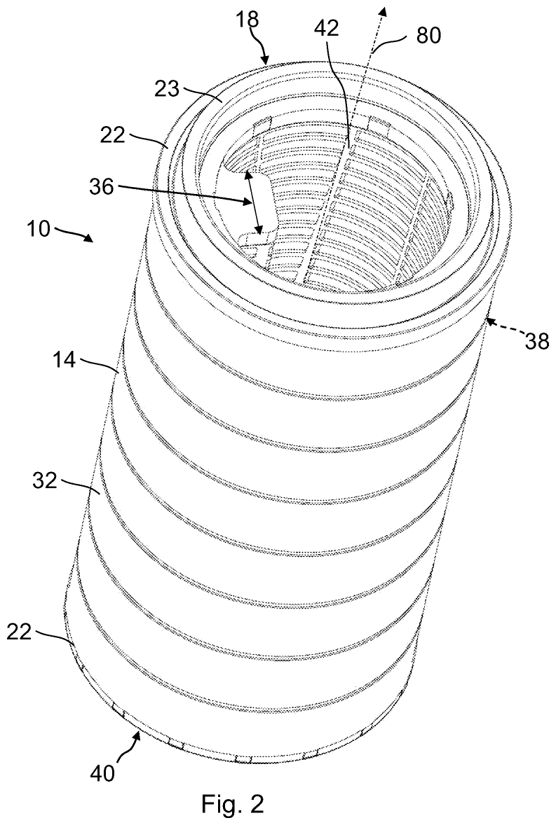

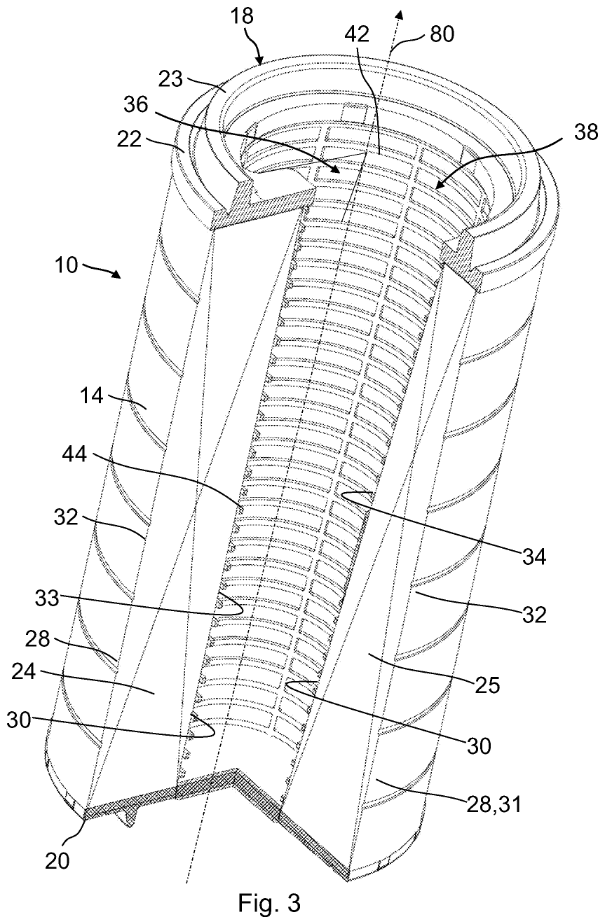

For explaining the invention, FIG. 1 shows a section illustration of a filter system 100 for fluid, for example air, for example of an internal combustion engine, comprising a filter element 10 according to an embodiment of the invention. FIG. 2 shows an isometric illustration of the filter element, while in FIG. 3 a section illustration of the filter element 10 is illustrated.

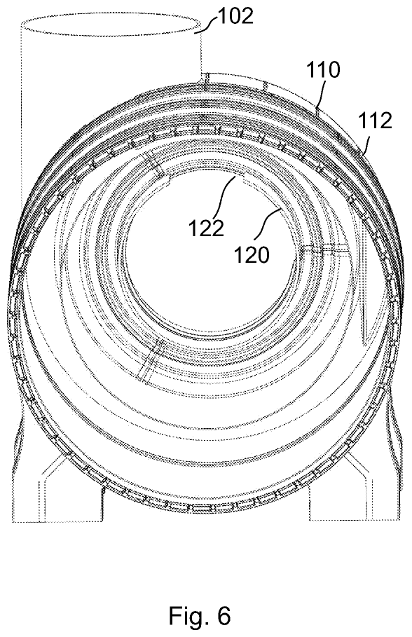

The filter system 100 comprises a housing 110 with a first housing part 112 and a second housing part 114, a fluid inlet 102 arranged at the housing 110 for supplying the fluid to be filtered (visible in FIG. 6), as well as a fluid outlet 104 arranged at the housing 110 for discharging the filtered fluid. Furthermore, the housing 110 comprises a dirt outlet 106 for discharging coarse dirt particles which are separated, for example, by a cyclone pre-separation.

A filter element 10 is arranged in the housing 110.

The filter element 10 comprises a filter medium body 14 with a filter medium 12 folded substantially in a star shape, which is arranged around a longitudinal axis 80 and comprises a closed circumference 40 and comprises a first end face 16 and a second end face 18 positioned oppositely thereto.

As seen for example in FIG. 3, the filter medium body 14 comprises, in at least one angular segment 36 around the longitudinal axis 80, first folds 24 with outer fold edges 28, which lie on an outer cylindrical wall surface 32, and radially oppositely positioned inner fold edges 30, which lie on an inner cylindrical wall surface 33 arranged inside of the outer cylindrical wall surface 32 in a radial direction. Furthermore, the filter medium body 14 comprises, at the same axial height in at least one second angular segment 38, second folds 25 with outer fold edges 28, 31, which lie on the outer cylindrical wall surface 32, and radially oppositely positioned inner fold edges 30, which lie on a conical wall surface 34 arranged inside of the outer cylindrical wall surface 32 in radial direction.

As an alternative, the filter medium body 14 could also comprise, at the same axial height in at least one second angular segment 38, second folds 25 with inner fold edges 30, which lie on an inner cylindrical wall surface 33, and radially oppositely positioned outer fold edges 28, 31, which lie on a conical wall surface 34 arranged outside of the inner cylindrical wall surface 32 in radial direction.

In the at least one second angular segment 38 comprising the conical wall surface 34, two or more second folds 25 may be present in at least one of the first folds 24 of the filter medium body 14 along the longitudinal axis 80. The second folds 25 are slanted toward the longitudinal axis 80. In the at least one second angular segment 38, first folds 24 may be for example present at the first end face 16 and second folds 25 present at the second end face 18.

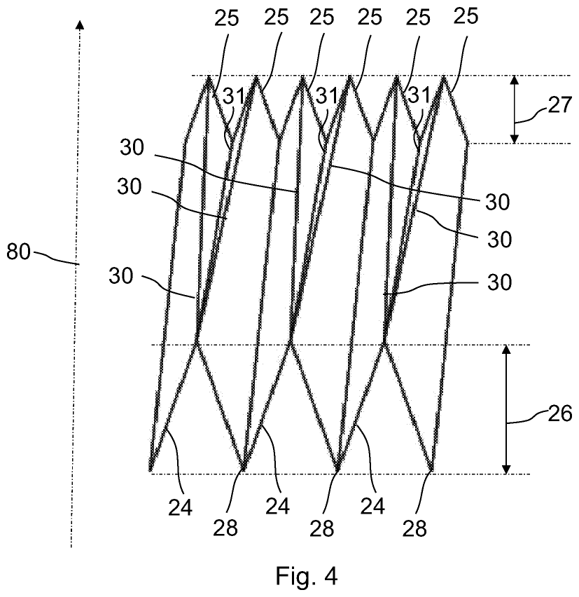

This may be seen in FIG. 4, where a schematic illustration of the transition from the first folds 24 to the second folds 25 of the folded filter medium 12 is illustrated.

In the at least one second angular segment 38, a fold height 26 of the second folds 25 changes continuously along the longitudinal axis 80 in this context. The second folds 25 in the at least one second angular segment 38 comprise half the fold height 27 of the fold height 26 of the first folds 24 in the at least one first angular segment 36.

In this embodiment, the number of the second folds 25 in relation to the number of the first folds 24 is doubled. Correspondingly, the number of inner fold edges 30 is duplicated also.

As seen for example in FIGS. 2 and 3, the filter medium body 14 comprises in the interior a support tube 42. In this context, the inner cylindrical wall surface 33 of the filter medium body 14 formed in the at least one first angular segment 36 engages a corresponding cutout 44 of the support tube 42 formed in the longitudinal direction 80.

The first and the second end faces 16, 18 of the filter medium body 14 each comprise an end disc 20, 22. In this context, the first and the second end faces 16, 18 of the filter medium body 14 are overmolded by a material of the end disc 20, 22. The support tube 42 is embedded in a respective end disc 20, 22 and may be overmolded by the material of the respective end discs 20, 22. The end discs 20, 22 comprise circumferentially extending seals 21, 23 protruding in longitudinal direction 80. In this context, the seals 21, 23 are integrated in the end discs.

In an alternative embodiment, also a plurality of first angular segments 36 and second angular segments 38 may be present at the filter element 10 which may be arranged alternatingly on a circumference of the filter medium body 14.

Furthermore, at least a portion of the outer cylindrical wall surface 32 of the filter medium body 14 may be covered by an inflow guard, not illustrated, which serves for protecting the filter medium body 14 from coarse particles of the inflowing fluid.

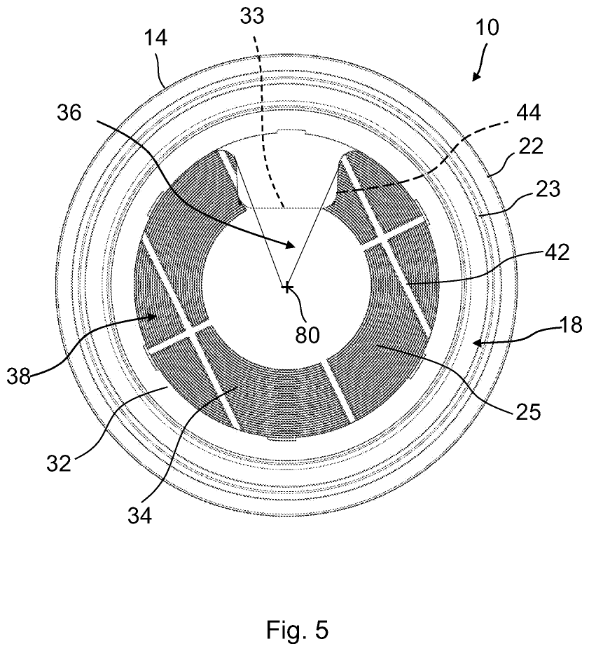

FIG. 5 shows a plan view of the second end face 18 of the filter element 10 according to FIGS. 2 and 3. The end disc 22 with the circumferential seal 23 closes off the filter medium body 14 at the second end face 18. In the interior of the filter element, the first angular segment 36 of the filter medium body 14 comprising the cylindrical wall surfaces 32, 33 may be seen as well as the second angular segment 38 comprising the conical wall surface 34 inwardly oriented in radial direction. Furthermore, stays of the support tube 42 may be seen. The first angular segment 36 of the filter medium body 14 is overmolded at the second end face 18 by the material of the end disc 22, as seen also in section in FIG. 3.

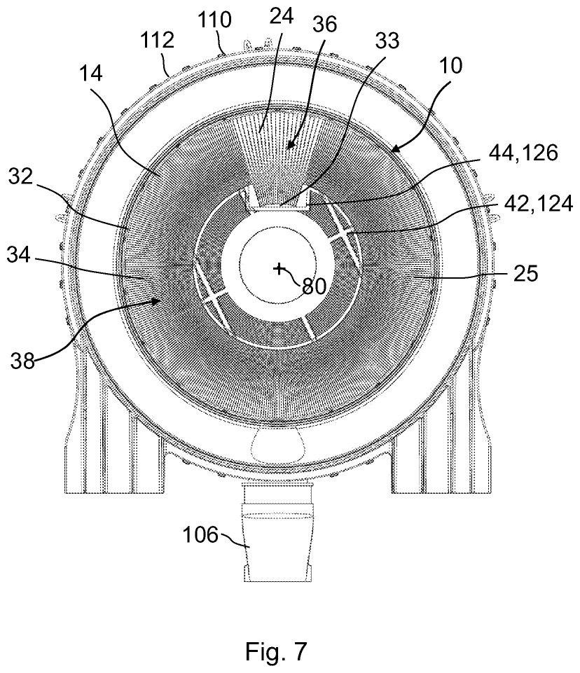

FIG. 6 shows an inner view of the first housing part 112 of the filter system 100 according to FIG. 1 while in FIG. 7 a section illustration through the filter system 100 in the section plane A-A according to FIG. 1 is illustrated.

When the filter element 10 is mounted as intended in the housing 110 of the filter system 100, a coupling element 120 of the housing 110 of the filter system 100, which is illustrated in FIG. 1 in section and in FIG. 6 in a plan view as a circumferential ring, engages in a longitudinal direction 80 the second angular segment 38 of a filter medium body 14 of the filter element 10 comprising a conical wall surface 34.

In the region of the at least one first angular segment 36 of the filter medium body 14 comprising a cylindrical wall surface 32, 33, the coupling element 120 comprises a cutout 122 in which the first angular segment 36 of the filter medium body 14 may engage.

In the section illustration in FIG. 7, it may be seen how the inner cylindrical wall surface 33 of the filter medium body 14 formed in the first angular segment 36 engages the corresponding cutout 44 of the support tube 42 formed in the longitudinal direction 80.

Due to the meshing of the first and second angular segments 36, 38 of the filter element 10 with the coupling element 120 and its cutout 122, a beneficial coupling possibility of the filter element 10 with the housing 110 of the filter system 100 is provided. In this way an oriented installation in the filter housing 110 is possible. In addition, an anti-rotation safeguard of the filter element 10 may be implemented. In this way, an anti-rotation mounting of the filter element 10 in the housing 110 of the filter system 100 may be ensured.

Due to the alternating arrangement of a plurality of first and second angular segments 36, 38 around the longitudinal axis 80, in addition a coding for matching filter elements 10 and filter systems 100 may be enabled.

In an alternative embodiment, the coupling element 120 may also be formed as a housing-fixed central tube 124 which receives the filter element 10 upon mounting as intended. In this context, an inner cylindrical wall surface 32 formed in at least one first angular segment 36 may engage a corresponding cutout 126 of the central tube 124 formed in longitudinal direction 80. In section in FIG. 7, the support tube 42 may also represent this housing-fixed central tube 124 with the corresponding cutout 126.

### REFERENCE CHARACTERS

10 filter element
12 filter medium
14 filter medium body
16 end face
18 end face
20 end disc
21 seal
22 end disc
23 seal
24 first fold
25 second fold
26 fold height
27 fold height
28 outer fold edge
30 inner fold edge
31 outer fold edge
32 outer cylindrical wall surface
33 inner cylindrical wall surface
34 conical wall surface
36 first angular segment
38 second angular segment
40 circumference
42 support tube
44 cutout
80 longitudinal axis
100 filter system
102 fluid inlet
104 fluid outlet
106 dirt outlet
110 filter housing
112 housing part
114 housing part
120 coupling element
122 cutout
124 central tube
126 cutout

That which is claimed is:

1. A filter element for a fluid, comprising:
a filter medium body comprising a filter medium, wherein the filter medium body is arranged around a longitudinal axis and comprises a closed circumference, wherein the filter medium body comprises a first end face and a second end face oppositely positioned to the first end face;
wherein the filter medium body comprises first folds arranged in at least one first angular segment of the filter medium body around the longitudinal axis;
wherein the first folds comprise first outer fold edges and radially oppositely positioned first inner fold edges;
wherein the first outer fold edges lie on an outer cylindrical wall surface of the filter medium body and wherein the radially oppositely positioned first inner fold edges lie on an inner cylindrical wall surface of the filter medium body arranged inside of the outer cylindrical wall surface in a radial direction in relation to the longitudinal axis;
wherein the filter medium body comprises second folds arranged in at least one second angular segment of the filter medium body in at least one region along the longitudinal axis at a same axial height;
wherein the second folds comprise second outer fold edges and radially oppositely positioned second inner fold edges;
wherein the second outer fold edges lie on the outer cylindrical wall surface and the radially oppositely positioned second inner fold edges lie on an inner conical wall surface of the filter medium body arranged inside of the outer cylindrical wall surface in the radial direction, or wherein the radially oppositely positioned second inner fold edges lie on the inner cylindrical wall surface and the second outer fold edges lie on an outer conical wall surface of the filter medium body arranged outside of the inner cylindrical wall surface in the radial direction.

2. The filter element according to claim 1, wherein, in the at least one second angular segment comprising the inner conical wall surface or the outer conical wall surface, two or more of the second folds are present along the longitudinal axis in one or more of the first folds of the filter medium body.

3. The filter element according to claim 2, wherein the one or more of the first folds are present at the first end face and the two or more second folds are present at the second end face in the at least one second angular segment.

4. The filter element according to claim 1, wherein a fold height of the second folds changes continuously along the longitudinal axis in the at least one second angular segment.

5. The filter element according to claim 1, wherein a fold height of the second folds in the at least one second angular segment amounts to half a fold height of the first folds in the at least one first angular segment.

6. The filter element according to claim 1, wherein the filter medium body comprises a support tube arranged in an interior of the filter medium body, wherein the support tube comprises a cutout extending in a direction of the longitudinal axis, wherein the inner cylindrical wall surface of the filter medium body formed in the at least one first angular segment engages the cutout of the support tube.

7. The filter element according to claim 6, wherein the filter medium body comprises a first end disc arranged at the first end face and further comprises a second end disc arranged at the second end face.

8. The filter element according to claim 7, wherein the first end face is overmolded by a material of the first end disc and wherein the second end face is overmolded by a material of the second end disc.

9. The filter element according to claim 7, wherein the support tube is embedded in the first end disc and the second end disc.

10. The filter element according to claim 7, wherein the first end disc and the second end disc each comprise a circumferential seal protruding in the direction of the longitudinal axis.

11. The filter element according to claim 10, wherein the circumferential seal of the first end disc is integrated in the first end disc and wherein the circumferential seal of the second end disc is integrated in the second end disc.

12. The filter element according to claim 1, wherein more than one of the at least one first angular segments and more than one of the at least one second angular segment are arranged alternatingly around a circumference of the filter medium body.

13. The filter element according to claim 1, wherein at least one portion of the outer cylindrical wall surface of the filter medium body is covered by an inflow guard.

14. A filter system for a fluid comprising:
the filter element according to claim 1;
a housing comprising a first housing part and a second housing part;
a fluid inlet arranged at the housing for supplying the fluid to be filtered;
a fluid outlet arranged at the housing for discharging the fluid that has been filtered;
wherein the housing comprises a coupling element engaging in a direction along the longitudinal axis the at least one second angular segment of the filter medium body of the filter element when the filter element is mounted in the housing.

15. The filter system according to claim 14, wherein the coupling element comprises a cutout in a region of the at least one first angular segment of the filter medium body.

16. The filter system according to claim 14, wherein the coupling element is a central tube fixed at the housing and configured to receive the filter element, wherein the central tube comprises a cutout formed in a direction of the longitudinal axis so as to correspond with the inner cylindrical wall surface of the at least one first angular segment of the filter medium body, and wherein the inner cylindrical wall surface of the at least one first angular segment engages the cutout of the central tube when the filter element is mounted in the housing.
